(19) United States
(12) Patent Application Publication
(10) Pub. No.: US 2022/0134466 A1
(43) Pub. Date: May 5, 2022

(54) SYSTEM AND METHOD OF RESISTIVE JOINING OF METAL SHEETS FOR A BATTERY CELL

(71) Applicants: GM Global Technology Operations LLC, Detroit, MI (US); Penn State Research Foundation, University Park, PA (US)

(72) Inventors: Nannan Chen, Warren, MI (US); Hongliang Wang, Warren, MI (US); James G. Schroth, Troy, MI (US)

(21) Appl. No.: 17/084,076

(22) Filed: Oct. 29, 2020

(51) Int. Cl. B23K 11/20

(52) U.S. Cl. CPC B23K 11/20; B23K 2103/18

(57) ABSTRACT

A method of resistive joining of metal sheets for a battery cell is provided. The method comprises providing an asymmetrical stackup comprising a first set of first metal sheets and a second set of second metal sheets. The first metal sheets arranged in sequence relative the second metal sheets defining the asymmetrical stackup. Each of the first and second metal sheets separated by a coating layer. The first metal sheets include a first material of a first melting point and the second metal sheets include a second material of a second melting point. The coating layer includes a third material of a third melting point. The first melting point is greater than the second melting point. The third melting point is greater than the second melting point and less than the first melting point. The method further comprises heating the first metal sheets to a first temperature to allow solid state bonding of the first metal sheets and to allow solid state bonding of the first set to the second set. The method further comprises heating the second metal sheets to a second temperature to allow fusion bonding of the second metal sheets.

### INTRODUCTION

The present disclosure relates joining metal sheets for battery cells and, more particularly, systems and methods of resistive joining of metal sheets for battery cells.

Battery pack assemblies are used in vehicles for hybrid and electric engines. During manufacturing of batteries, a discrepancy of melting temperatures may create discontinuous bonds at interfaces. Such discrepancies make resistive joining of asymmetrical stackups challenging.

### SUMMARY

Thus, while current manufacturing processes and systems achieve their intended purpose, there is a need for a new and improved system and method of joining metal sheets for battery cells

According to one aspect of the present disclosure, a method of resistive joining of metal sheets for a battery cell is provided. The method comprises providing an asymmetrical stackup comprising a first set of first metal sheets and a second set of second metal sheets. The first metal sheets are arranged in sequence relative the second metal sheets defining the asymmetrical stackup. Each of the first and second metal sheets are separated by a coating layer. The first metal sheets include a first material of a first melting point and the second metal sheets include a second material of a second melting point. The coating layer includes a third material of a third melting point. The first melting point is greater than the second melting point. The third melting point is greater than the second melting point and less than the first melting point.

In this example, the method further comprises heating the first metal sheets to a first temperature to allow solid state bonding of the first metal sheets and to allow solid state bonding of the first set to the second set. Moreover, the method further includes heating the second metal sheets to a second temperature to allow fusion bonding of the second metal sheets.

In another example of this aspect, the first material includes copper and the first melting point is about 1084 degrees Celsius.

In another example, the second material includes aluminum and the second melting point is about 660 degrees Celsius.

In yet another example of this aspect, the third material includes nickel-phosphorous and the third melting point is about 1000 degrees Celsius.

In still another example, the first temperature is about 1000 degrees Celsius and the second temperature is about 800 degrees Celsius.

In yet another example of this aspect, the first temperature is between about 660° C. and about 1000° C. and wherein the second temperature is between about 660° C. and about 800° C.

In another example, the first temperature is between about 800° C. and about 1000° C. and wherein the second temperature is between about 660° C. and about 1000° C.

In another aspect of the present disclosure, a method of resistive joining of metal sheets for a battery cell is provided. The method comprises providing an asymmetrical stackup comprising a first set of first metal sheets and a second set of second metal sheets. The first metal sheets are arranged in sequence relative the second metal sheets defining the asymmetrical stackup. Each of the first and second metal sheets are separated by a coating layer. The first metal sheets include a first material of a first melting point and the second metal sheets include a second material of a second melting point. The coating layer includes a third material of a third melting point. The first melting point is greater than the second melting point. The third melting point is greater than the second melting point and less than the first melting point.

In this aspect, the method comprises solid state bonding the first metal sheets by heating the first metal sheets at a first temperature. The method further comprises fusion bonding the second metal sheets by heating the second metal sheets at a second temperature. The method further comprises solid state bonding the first set to the second set when heating the first metal sheets at the first temperature.

In another example of this aspect, the first material includes copper and the first melting point is about 1084 degrees Celsius.

In another example, the second material includes aluminum and the second melting point is about 660 degrees Celsius.

In yet another example of this aspect, the third material includes nickel-phosphorous and the third melting point is about 1000 degrees Celsius.

In still another example, the first temperature is about 1000 degrees Celsius and the second temperature is about 800 degrees Celsius.

In another example, the first temperature is between about 660° C. and about 1000° C. and wherein the second temperature is between about 660° C. and about 800° C.

In yet another example, the first temperature is between about 800° C. and about 1000° C. and wherein the second temperature is between about 660° C. and about 1000° C.

In yet another aspect of the present disclosure, a system for resistive joining of metal sheets for a battery cell is disclosed. The system comprises an asymmetrical stackup comprising a first set of first metal sheets and a second set of second metal sheets. The first metal sheets are arranged in sequence relative the second metal sheets defining the asymmetrical stackup. The asymmetrical stackup has a first side and a second side. The first side includes one of the first metal sheets arranged in sequence and the second side including one of the second metal sheets arranged in sequence. Each of the first and second metal sheets are separated by a coating layer. The first metal sheets include a first material of a first melting point and the second metal sheets include a second material of a second melting point. The coating layer includes a third material of a third melting point. The first melting point is greater than the second melting point. The third melting point is greater than the second melting point and less than the first melting point.

In this embodiment of the present disclosure, the system further comprises a first electrode having a first resistivity and a first thermal conductivity. The first electrode is configured to contact the first side of the asymmetrical stackup to heat the first set at a first temperature for solid state bonding the first metal sheets and for solid state bonding of the first set to the second set.

In this embodiment of this aspect of the present disclosure, a second electrode has a second resistivity and a second thermal conductivity. The second electrode is configured to contact the second side of the asymmetrical stackup to heat the second set at a second temperature for fusion bonding the second metal sheets at a second temperature. The first resistivity is greater than the second resistivity.

In this embodiment, the system further comprises a power source is configured to power the first and second electrodes. The system further comprises a controller configured to control the power to the first and second electrodes to heat the asymmetrical stackup.

In one embodiment of this aspect, the first thermal conductivity is less than the second thermal conductivity.

In another embodiment, the first electrode is one of pure Molybdenum and pure Tungsten and, in this or yet another embodiment, the second electrode is one of Copper-Tungsten alloy, Copper-Zirconium alloy, and Copper chromium alloy.

In still another embodiment, the first material includes Copper and the first melting point is about 1084 degrees Celsius, and the second material includes Aluminum and the second melting point is about 660 degrees Celsius.

In another embodiment, the first temperature is between about 800° C. and about 1000° C., and the second temperature is between about 660° C. and about 1000° C.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for resistive joining of metal sheets for a battery cell in accordance with one embodiment of the present disclosure.

FIG. 2 is a flowchart of one method of resistive joining of metal sheets for a battery cell implemented by the system in FIG. 1 in accordance with one example of the present disclosure.

FIG. 3 is a flowchart of another method of resistive joining of metal sheets for a battery cell implemented by the system in FIG. 1 in accordance with another example.

### DETAILED DESCRIPTION

The following description is merely exemplary in nature and is not intended to limit the present disclosure, application, or uses.

The present disclosure provides a system and method to unevenly distribute energy during a process of joining metal sheets for a battery cell. The system and methods disclosed herein provide more heat to one set of metal sheets and less heat to another set of metal sheets of an asymmetrical stackup. The system and methods provide a more continuous solid weld.

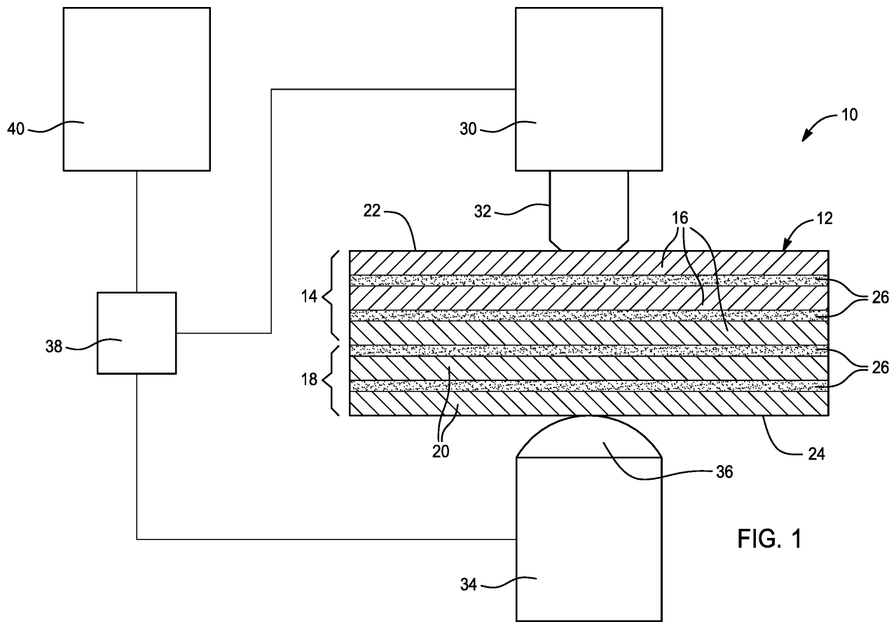

In accordance with one embodiment of the present disclosure, FIG. 1 illustrates a system 10 for resistive joining of metal sheets for a battery cell. As shown, the system 10 comprises an asymmetrical stackup 12 comprising a first set 14 of first metal sheets 16 and a second set 18 of second metal sheets 20. That is, the first metal sheets 16 are arranged in sequence relative the second metal sheets 20 and the second metal sheets 20 are arranged in sequence relative to the first metal sheets 16 to define the asymmetrical stackup 12.

In this embodiment, the first metal sheets 16 include a first material and the second metal sheets 20 include a second material. The first material preferably is copper and has a first melting point. Moreover, the second material preferably is aluminum and has a second melting point. The first melting point is preferably 1084 degree Celsius and the second melting point is preferably 660 degree Celsius.

As shown in FIG. 1, the asymmetrical stackup 12 has a first side 22 and a second side 24. The first side 22 includes one of the first metal sheets 16 arranged in sequence and the second side 24 includes one of the second metal sheets 20 arranged in sequence. Each of the first and second metal sheets 20 are separated by a coating layer 26. The coating layer 26 includes a third material having a third melting point. In this embodiment, the third material includes nickel-phosphorous and the third melting point is about 1000 degrees Celsius.

Additionally, the first melting point is greater than the second melting point. Moreover, the third melting point is greater than the second melting point and less than the first melting point. In this example, copper (the first material) has a melting point of 1084 degrees Celsius which is greater than 660 degrees Celsius, the melting point of aluminum (the second material). Furthermore, nickel-phosphorous (the third material) has a melting point of 1000 degrees Celsius which is greater than 660 degrees Celsius, the melting point of aluminum, and less than 1084 degrees Celsius, the melting point of copper.

Referring to FIG. 1, the system 10 further comprises a first electrode 30 having a first tip 32 having a first resistivity and a first thermal conductivity. The first tip 32 of the first electrode 30 is configured to contact the first side 22 of the asymmetrical stackup 12 to heat the first set 14 at a first temperature for solid state bonding the first metal sheets 16 and for solid state bonding of the first set 14 to the second set 18.

Moreover, the system 10 further comprises a second electrode 34 having a second tip 36 having second resistivity and a second thermal conductivity. The second tip 36 of the second electrode 34 is configured to contact the second side 24 of the asymmetrical stackup 12 to heat the second set 18 at a second temperature for fusion bonding the second metal sheets 20 at a second temperature. In this embodiment, the first resistivity is greater than the second resistivity and the first thermal conductivity is less than the second conductivity.

In this embodiment, the first temperature is preferably between about 660° C. and about 1000° C., more preferably between about 800° C. and about 1000° C., and even more preferably about 1000 degrees Celsius. Moreover, the second temperature is preferably between about 660° C. and about 1000° C., more preferably between about 660° C. and about 800° C., and even more preferably about 800 degrees Celsius.

In this embodiment of the present disclosure, the system 10 further comprises a power source 38 connected to the first and second electrodes 30, 34. The power source 38 is configured to power the first and second electrodes 30, 34. The power source 38 may be any power source unit such as a transducer without departing from the scope or spirit of the present disclosure. As shown, the system 10 further comprises a controller 40 in communication with the power source 38. The controller 40 is configured to control the power to the first and second electrodes 30, 34 to heat the asymmetrical stackup 12.

In this embodiment, the first tip 32 of the first electrode 30 is one of pure Molybdenum and pure Tungsten. Moreover, the second tip 36 of the second electrode 34 is one of Copper-Tungsten alloy, Copper-Zirconium alloy, and Copper chromium alloy. It is to be understood that the first tip 32 and second tip 36 may be of any other suitable material without departing from the scope or spirit of the present disclosure so long as the first tip 32 has a greater resistivity and a lower thermal conductivity relative to the second tip 36.

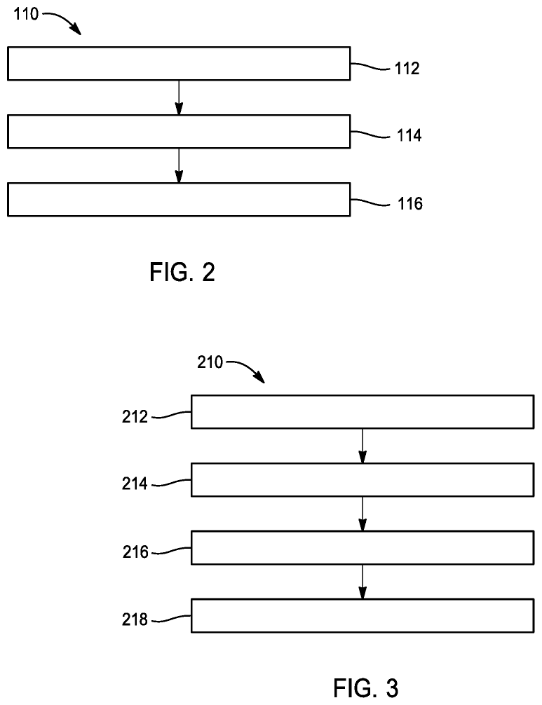

FIG. 2 illustrates a method 110 of resistive joining of metal sheets for a battery cell in accordance with the system 10 of FIG. 1. As shown, the method 110 comprises in box 112 providing an asymmetrical stackup 12 comprising a first set 14 of first metal sheets 16 and a second set 18 of second metal sheets 20. As discussed above, the first metal sheets 16 are arranged in sequence relative the second metal sheets 20 and the second metal sheets 20 are arranged in sequence relative to the first metal sheets 16 to define the asymmetrical stackup 12.

As in the system 10 of FIG. 1, the method 110 of FIG. 2 comprises the first metal sheets 16 including a first material and the second metal sheets 20 including a second material. As in this example, the first material preferably is copper and has a first melting point. Moreover, the second material preferably is aluminum and has a second melting point. The first melting point is preferably 1084 degrees Celsius and the second melting point is preferably 660 degrees Celsius.

As well in this example, the asymmetrical stackup 12 has a first side 22 and a second side 24. The first side 22 includes one of the first metal sheets 16 arranged in sequence and the second side 24 includes one of the second metal sheets 20 arranged in sequence. Each of the first and second metal sheets 20 are separated by a coating layer 26. In this example, the coating layer 26 includes a third material having a third melting point. In this embodiment, the third material includes nickel-phosphorous and the third melting point is about 1000 degrees Celsius.

Additionally, the first melting point is greater than the second melting point. Moreover, the third melting point is greater than the second melting point and less than the first melting point. As in the example discussed above, copper (the first material) has a melting point of 1084 degrees Celsius which is greater than 660 degrees Celsius which is the melting point of aluminum (the second material). Furthermore, nickel-phosphorous (the third material) has a melting point of 1000 degrees Celsius which is greater than 660 degrees Celsius, the melting point of aluminum, and less than 1084 degrees Celsius, the melting point of copper.

In this example, the method 110 further comprises in box 114 heating the first metal sheets 16 to a first temperature to allow solid state bonding of the first metal sheets 16 and to allow solid state bonding of the first set 14 to the second set 18. Moreover, the method further includes in box 116 heating the second metal sheets 20 to a second temperature to allow fusion bonding of the second metal sheets 20.

Steps 114 and 116 may be accomplish with the system 10 depicted in FIG. 1. That is, the first electrode 30 may be implemented to generate heat on the first set 14 of first metal sheets 16 and the second electrode 34 may be implemented to generate heat on the second set 18 of the second metal sheets 20. As such, the first tip 32 of the first electrode 30 contacts the first side 22 and the second tip 36 of the second electrode 34 contacts the second side 24 of the asymmetrical stackup 12. When power is delivered via the controller 40 and the power source 38, the first tip 32 heats the first set 14 of first metal sheets 16 to the first temperature and the second tip 36 heats the second set 18 of second metal sheets 20 to the second temperature. Due to the difference in resistivity/thermal conductivity of the first and second tips 32, 36, heat is generated to both the first and second sets 14, 18 wherein a higher temperature (the first temperature) is generated to the first metal sheets 16 and a lower temperature (the second temperature) is generated to the second metal sheets 20. In this example, the first metal sheets 16 comprise copper and the second metal sheets 20 comprise aluminum.

As in this example, the first temperature is preferably between about 660° C. and about 1000° C., more preferably between about 800° C. and about 1000° C., and even more preferably about 1000 degrees Celsius. Moreover, the second temperature is preferably between about 660° C. and about 1000° C., more preferably between about 660° C. and about 800° C., and even more preferably about 800 degrees Celsius.

The first temperature (the higher temperature), e.g. 1000 degrees Celsius, at the first set 14 of metal sheets results in solid state bonding of the first metal sheets 16 and solid state bonding of the first set 14 to the second set 18. The second temperature (the lower temperature), e.g. 660 degrees Celsius, at the second set 18 of metal sheets results in fusion bonding of the second set 18 of second metal sheets 20. When the second set 18 of second metal sheets 20 are heated, the coating layer 26 being made of a higher resistivity than the second material helps generate heat to the second metal sheets 20 to the second temperature allowing fusion bonding.

FIG. 3. depicts a method 210 of resistive joining of metal sheets for a battery cell in accordance to the system 10 of FIG. 1. As shown, the method 210 comprises in box 212 providing an asymmetrical stackup 12 comprising a first set 14 of first metal sheets 16 and a second set 18 of second metal sheets 20. As discussed above, the first metal sheets 16 are arranged in sequence relative the second metal sheets 20 and the second metal sheets 20 are arranged in sequence relative to the first metal sheets 16 to define the asymmetrical stackup 12.

As in the system 10 of FIG. 1, the method 210 of FIG. 3 comprises the first metal sheets 16 including a first material and the second metal sheets 20 including a second material. As in this example, the first material preferably is copper and has a first melting point. Moreover, the second material preferably is aluminum and has a second melting point. The first melting point is preferably 1084 degrees Celsius and the second melting point is preferably 660 degrees Celsius.

As well in this example, the asymmetrical stackup 12 has a first side 22 and a second side 24. The first side 22 includes one of the first metal sheets 16 arranged in sequence and the second side 24 includes one of the second metal sheets 20 arranged in sequence. Each of the first and second metal sheets 20 are separated by a coating layer 26. In this example, the coating layer 26 includes a third material having a third melting point. In this embodiment, the third material includes nickel-phosphorous and the third melting point is about 1000 degrees Celsius.

Additionally, the first melting point is greater than the second melting point. Moreover, the third melting point is greater than the second melting point and less than the first melting point. As in the example discussed above, copper (the first material) has a melting point of 1084 degrees Celsius which is greater than 660 degrees Celsius which is the melting point of aluminum (the second material). Furthermore, nickel-phosphorous (the third material) has a melting point of 1000 degrees Celsius which is greater than 660 degrees Celsius, the melting point of aluminum, and less than 1084 degrees Celsius, the melting point of copper.

In this aspect, the method 210 comprises in box 214 solid state bonding the first metal sheets 16 by heating the first metal sheets 16 at a first temperature. Solid state bonding may be viewed as bonding by material interdiffusion at an elevated temperature. The method 210 further comprises in box 216 fusion bonding the second metal sheets 20 by heating the second metal sheets 20 at a second temperature. Fusion bonding may be viewed as direct bonding including melting at an elevated temperature. The method 210 further comprises in box 218 solid state bonding the first set 14 to the second set 18 when heating the first metal sheets 16 at the first temperature.

Steps 214, 216, and 218 may be accomplish with the system 10 depicted in FIG. 1. That is, the first electrode 30 may be implemented to generate heat on the first set 14 of the first metal sheets 16 and the second electrode 34 may be implemented to generate heat on the second set 18 of the second metal sheets 20. As such, the first tip 32 of the first electrode 30 contacts the first side 22 and the second tip 36 of the second electrode 34 contacts the second side 24 of the asymmetrical stackup 12. When power is delivered via the controller 40 and the power source 38, the first tip 32 heats the first set 14 of first metal sheets 16 to the first temperature and the second tip 36 heats the second set 18 of second metal sheets 20 to the second temperature.

Due to the difference in resistivity/thermal conductivity of the first and second tips 32, 36, heat is generated to both the first and second sets 14, 18 wherein a higher temperature (the first temperature) is generated to the first metal sheets 16 and a lower temperature (the second temperature) is generated to the second metal sheets 20. In this example, the first metal sheets 16 comprise copper and the second metal sheets 20 comprise aluminum.

As in this example, the first temperature is preferably between about 660° C. and about 1000° C., more preferably between about 800° C. and about 1000° C., and even more preferably about 1000 degrees Celsius. Moreover, the second temperature is preferably between about 660° C. and about 1000° C., more preferably between about 660° C. and about 800° C., and even more preferably about 800 degrees Celsius.

The first temperature (the higher temperature), e.g. 1000 degrees Celsius, generated at the first set 14 of first metal sheets 16 results in solid state bonding of the first metal sheets 16 along with solid state bonding of the first set 14 to the second set. The second temperature (the lower temperature), e.g. 660 degrees Celsius, generated at the second set of second metal sheets 20 results in fusion bonding of the second set of second metal sheets 20. When the second set of second metal sheets 20 are heated, the coating layer 26 being made of a higher resistivity than the second material helps generate heat to the second metal sheets 20 to the second temperature allowing fusion bonding.

Further areas of applicability will become apparent from the description provided herein. It should be understood that the description and specific examples are intended for purposes of illustration only and are not intended to limit the scope of the present disclosure.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of resistive joining of metal sheets for a battery cell, the method comprising:
providing an asymmetrical stackup comprising a first set of first metal sheets and a second set of second metal sheets, the first metal sheets arranged in sequence relative to the second metal sheets defining the asymmetrical stackup, each for the first and second metal sheets separated by a coating layer, the first metal sheets including a first material of a first melting point and the second metal sheets including a second material of a second melting point, the coating layer including a third material of a third melting point, the first melting point being greater than the second melting point, the third melting point being greater than the second melting point and less than the first melting point;
heating the first metal sheets to a first temperature to allow solid state bonding of the first metal sheets and to allow solid state bonding of the first set to the second set; and
heating the second metal sheets to a second temperature to allow fusion bonding of the second metal sheets.

2. The method of claim 1 wherein the first material includes Copper and the first melting point is about 1084 degrees Celsius.

3. The method of claim 1 wherein the second material includes Aluminum and the second melting point is about 660 degrees Celsius.

4. The method of claim 1 wherein the third material includes Nickel-Phosphorous and the third melting point is about 1000 degrees Celsius.

5. The method of claim 1 wherein the first temperature is about 1000 degrees Celsius and the second temperature is about 800 degrees Celsius.

6. The method of claim 1 wherein the first temperature is between about 660° C. and about 1000° C. and wherein the second temperature is between about 660° C. and about 800° C.

7. The method of claim 1 wherein the first temperature is between about 800° C. and about 1000° C. and wherein the second temperature is between about 660° C. and about 1000° C.

8. A method of resistive joining of metal sheets for a battery cell, the method comprising:
providing an asymmetrical stackup comprising a first set of first metal sheets and a second set of second metal sheets, the first metal sheets arranged in sequence relative to the second metal sheets defining the asymmetrical stackup, each of the first and second metal sheets separated by a coating layer, the first metal sheets including a first material of a first melting point and the second metal sheets including a second material of a second melting point, the coating layer including a third material of a third melting point, the first melting point being greater than the second melting point, the third melting point being greater than the second melting point and less than the first melting point;
solid state bonding the first metal sheets by heating the first metal sheets at a first temperature; and
fusion bonding the second metal sheets by heating the second metal sheets at a second temperature;
solid state bonding the first set to the second set when heating the first metal sheets at the first temperature.

9. The method of claim 8 wherein the first material includes Copper and the first melting point is about 1084 degrees Celsius.

10. The method of claim 8 wherein the second material includes Aluminum and the second melting point is about 660 degrees Celsius.

11. The method of claim 8 wherein the third material includes Nickel-Phosphorous and the third melting point is about 1000 degrees Celsius.

12. The method of claim 8 wherein the first temperature is about 1000 degrees Celsius and the second temperature is about 800 degrees Celsius.

13. The method of claim 8 wherein the first temperature is between about 660° C. and about 1000° C. and wherein the second temperature is between about 660° C. and about 800° C.

14. The method of claim 8 wherein the first temperature is between about 800° C. and about 1000° C. and wherein the second temperature is between about 660° C. and about 1000° C.

15. A system for resistive joining of metal sheets for a battery cell, the system comprising:
an asymmetrical stackup comprising a first set of first metal sheets and a second set of second metal sheets, the first metal sheets arranged in sequence relative to the second metal sheets defining the asymmetrical stackup, the asymmetrical stackup having a first side and a second side, the first side including one of the first metal sheets arranged in sequence and the second side including one of the second metal sheets arranged in sequence, each of the first and second metal sheets separated by a coating layer, the first metal sheets including a first material of a first melting point and the second metal sheets including a second material of a second melting point, the coating layer including a third material of a third melting point, the first melting point being greater than the second melting point, the third melting point being greater than the second melting point and less than the first melting point;
a first electrode having a first resistivity and a first thermal conductivity, the first electrode configured to contact with the first side of the asymmetrical stackup to heat the first set at a first temperature for solid state bonding the first metal sheets and for solid state bonding of the first set to the second set;
a second electrode having a second resistivity and a second thermal conductivity, the second electrode configured to contact the second side of the asymmetrical stackup to heat the second set at a second temperature for fusion bonding the second metal sheets at a second temperature, the first resistivity being greater than the second resistivity;
a power source configured to power the first and second electrodes; and
a controller configured to control the power to the first and second electrodes to heat the asymmetrical stackup.

16. The system of claim 15 wherein the first thermal conductivity is less than the second thermal conductivity.

17. The system of claim 15 wherein the first electrode is one of pure Molybdenum and pure Tungsten.

18. The system of claim 15 wherein the second electrode is one of Copper-Tungsten alloy, Copper zirconium alloy, and Copper chromium alloy.

19. The system of claim 15 wherein the first material includes Copper and the first melting point is about 1084 degrees Celsius, and wherein the second material includes Aluminum and the second melting point is about 660 degrees Celsius.

20. The system of claim 19 wherein the first temperature is between about 800° C. and about 1000° C. and wherein the second temperature is between about 660° C. and about 1000° C.
